(19) United States
(12) Patent Application Publication
(10) Pub. No.: US 2026/0193976 A1
(43) Pub. Date: Jul. 9, 2026

(54) METHOD AND SYSTEM FOR CEMENTING SIMULATION AND GAS-WATER BACK-INVASION EVALUATION IN COMPLEX FORMATIONS

(71) Applicant: Chengdu University of Technology, Chengdu (CN)

(72) Inventors: Mingming ZHENG, Chengdu (CN); Yuxi DENG, Chengdu (CN); Zurui WU, Chengdu (CN); Yawei ZHANG, Chengdu (CN); Hui DENG, Chengdu (CN); Jun ZHAO, Chengdu (CN); Fei WANG, Chengdu (CN); Shichun YAN, Chengdu (CN); Kesai LI, Chengdu (CN); Yichen DU, Chengdu (CN)

(73) Assignee: Chengdu University of Technology, Chengdu (CN)

(21) Appl. No.: 19/442,954

(22) Filed: Jan. 7, 2026

(30) Foreign Application Priority Data
Jan. 8, 2025 (CN) 2025100300269

(51) Int. Cl. E21B 47/005; G01N 19/04

(52) U.S. Cl. CPC E21B 47/005; G01N 19/04

(57) ABSTRACT

The present disclosure discloses a method and system for cementing simulation and gas-water back-invasion evaluation in complex formations, and relates to oil and natural gas extraction technologies. The evaluation system is provided with a simulated formation, a buffer space, a cement ring and a casing, and a movable bottom plate; two groups of hydraulic cylinders are provided below the movable bottom plate to test a shear force of a secondary interface and a compressive strength of the cement ring, respectively; the casing has a casing cavity and a cement return hole, and the cement ring is formed after cement returns and solidifies; and sonic logging probes and a gas detection device are provided within a reaction vessel. The evaluation method adopts the evaluation system described above for evaluation.

### CROSS-REFERENCE TO RELATED APPLICATIONS

The application claims priority to Chinese patent application No. 2025100300269, filed on Jan. 8, 2025, the entire contents of which are incorporated herein by reference.

### TECHNICAL FIELD

The present disclosure relates to oil and natural gas extraction technologies, in particular to a method and system for cementing simulation and gas-water back-invasion evaluation in complex formations.

### BACKGROUND

Extraction of oil and natural gas requires going through a complex series of processes, including drilling, cementing, completion, perforating, water injection, oil extraction, and the like. A cementing operation is an important procedure in the energy exploitation process, and has an important role in providing protection and support to a casing and performing effective zonal isolation on adjacent formations; in particular, in the deep water oil and gas exploration and development, the cementing quality directly determines the service life of a production well, has an important effect on the successful performance and recovery of each subsequent link, and is a key project for the long-term stable production of an oil field, so that the evaluation on the cementing quality is completely necessary.

The key to the cementing quality is cementing quality of a secondary interface, including primarily a cementing strength and a zonal isolation capacity. Currently, methods for evaluating the cementing quality of the secondary interface can be mainly summarized into two categories, i.e., an on-site logging evaluation method and an evaluation method of an interface cementing strength in a laboratory experiment. The evaluation method of the interface cementing strength in the laboratory experiment is mainly that a simulated formation is formed first, and then a certain amount of cement slurry is injected into space adjacent to the simulated formation and solidifies to form a cement ring (a contact surface between the cement ring and the simulated formation is the secondary interface); and the cementing strength of the secondary interface is characterized by a shear strength obtained by measuring a shear behavior parallel to the secondary interface, and meanwhile, the zonal isolation capacity is characterized by the permeability of the secondary interface between a cement slurry body and the simulated formation.

Deep water oil and gas resources are widely distributed, including coastal continental shelf areas, at the same time, hydrates are also widely distributed in shallow surface sediments of the ocean, and the two have a very high coincidence degree in geographic position, so that hydrate formations are very likely to be encountered during surface cementing in the deep-water oil and gas exploration and development processes. The hydrates are a type of stable solid compounds formed under specific temperature and pressure conditions. However, when external conditions such as temperature and pressure are changed, the hydrates may be decomposed to produce a large amount of gas and water, which pose challenges for the cementing operation. In the cementing process, heat release due to hydration of the cement slurry causes the decomposition of hydrates in a simulated wellbore ring wall, producing high-pressure free gas and water. These high-pressure free gas and water are highly susceptible to backward invade into the cement slurry (i.e., gas-water back-invasion), severely affecting a mechanical strength of the cementing cement ring and a sealing property of a cementing secondary interface, even causing cementing failures and well wall destabilization, and causing safety incidents such as blowouts. In order to prevent the occurrence of gas-water back-invasion phenomena, the discrimination of critical conditions for gas-water back-invasion under different geological conditions and cementing process conditions is essential. Theoretical guidance and basis for cementing plan designing and cementing process parameter optimization can be provided by evaluating the impacts of gas-water back-invasion on the cementing quality such as mechanical and barrier properties of the cement ring and the secondary interface through simulation analysis of physical property responses of hydrate formations under different geological conditions and cementing process conditions and high-pressure gas-water back-invasion laws. Therefore, in the evaluation process of the interface cementing strength of the laboratory experiment, pore water and methane gas are injected into the simulated formation and are allowed to form hydrates to make the simulated formation closer to a natural formation containing hydrates, but due to the action of gravity, the distribution of pore water in the simulated formation is not uniform, and it is difficult to ensure uniform generation of hydrates in the simulated formation.

In the cementing process, a secondary interface morphology is not flat due to a certain degree of invasion of cement slurry into the simulated wellbore ring wall, and the hydrates in the hydrate-containing simulated formation are very easily decomposed to produce high-pressure free gas and water which backwards invade into cement, so that the secondary interface morphology and microfracture observation are also beneficial to analytical investigation of a secondary interface strength and sealing performance; and fewer cementing quality evaluation experimental devices in the prior art take into account the secondary interface morphology and microfracture observation.

Furthermore, in order to achieve safe stabilization of the well wall in the cementing process and improve the cementing quality of the secondary interface, the cementing cement slurry pressure is generally greater than the pore pressure of the simulated formation, when the cement slurry penetrates into the simulated formation under the action of the differential pressure, due to the limited thickness of the simulated formation, pores in the simulated formation are subjected to pressure generated by cement slurry invasion into the simulated wellbore ring wall (the simulated wellbore ring wall refers to the formation near the well wall), resulting in pore distribution, pressure non-uniformity, pressure building, etc. in the simulated formation, and there is a significant difference compared with the downhole in-situ formation during cementing (the downhole in-situ formation refers to the formation related to cementing that is formed after drilling), which affects the quality evaluation accuracy of the cement ring and the interface. Meanwhile, in the evaluation process of the interface cementing strength of the laboratory experiment, the data analysis of sonic logging probes evaluates the cementing quality of the cement slurry, which is provided in such a way that the gas tightness of the device is affected and thus the pressure stabilization of the device is affected, and the pressure stabilization difference makes the test result inaccurate. The above problems increase the difficulty and accuracy of the evaluation of the cementing strength and the zonal isolation capacity.

There have been a lot of prior arts on the evaluation of cementing quality, for example, CN206707694A discloses an experimental device for evaluating cementing quality of a hydrate formation in deep water cementing. The device evaluates cementing quality of cement slurry only by data analysis of sonic logging probes and does not consider the influence of a secondary interface strength, resulting in lower accuracy of cementing quality evaluation results; a prefabricated artificial natural gas hydrate differs greatly from a hydrate in a natural formation under actual conditions, and experimental results are of low confidence; and the cement slurry is injected from a bottom of a vessel body, which is contrary to actual construction situations (under the actual construction situations, the cement slurry is injected from a wellhead, i.e., injected from top to bottom), a cementing pressure differential caused by the injection of cement slurry (requiring the pressure of the cement slurry to be greater than the pressure of the simulated formation) is affected by a cement slurry pump, and the experimental results are of low confidence.

CN110778291 A discloses an experimental device for simulating natural gas hydrate formation cementing. The device detects only temperature and pressure in a simulated hydrate formation in the cementing process, and cannot accurately evaluate the cementing quality; due to pressure building, local pressure non-uniformity, excessive local pressure, etc. generated by an instrument itself, the seepage process of the cement slurry in the pores of the simulated formation enables the prefabricated artificial natural gas hydrate to differ greatly from a hydrate in a natural formation under actual conditions, and the experimental results are of low confidence; and thermal decomposition and back-invasion processes of the hydrate cannot be observed in real time.

In CN109142192A, our team discloses a visual special-shaped cementing secondary interface cementing quality and special-shaped body strength test system. A simulated formation cavity is in communication with a cementing cement/cement stone cavity to form an experimental cavity; the top and bottom of the experimental cavity are sealed, a lower portion of the cementing cement/cement stone cavity is provided with a cement stone lifting mold; a thermocouple and a plurality of reactant gas injection pipes are provided in the simulated formation cavity, and visual windows are provided on sides of the simulated formation cavity and the cementing cement/cement stone cavity, respectively. The device can be used for evaluating the secondary interface cementing quality in the cementing process of hydrate-containing formations and testing the quality of soft soil formation soil bodies and cementing surfaces, and visualization of the secondary interface morphology and microfractures is achieved to some extent. However, this technology still suffers from the following drawbacks:
1. due to pressure building, local pressure non-uniformity, excessive local pressure, etc. generated by an instrument itself, the seepage process of the cement slurry in the pores of the simulated formation enables the prefabricated artificial natural gas hydrate to differ greatly from a hydrate in a natural formation under actual conditions, and the experimental results are of low confidence;
2. a visualization observation head is outside the secondary interface, the use of an opaque rubber film tube in order to realize a sealed environment of confining pressure results in the inability to realize real-time observation of thermal decomposition and back-invasion processes of the hydrate, and the need to disassemble the rubber film tube when observing the secondary interface makes operations troublesome; the removal of the rubber film tube and real-time observation of the thermal decomposition and back-invasion processes of the hydrate can be achieved only when no additional use of the rubber film tube is required to form the sealed environment, thus limiting the scenes that can be observed in real time; and
3. calculation of permeability is required when the cementing quality is evaluated, the process is complicated, and errors are large.

### SUMMARY

For a series of problems such as a large difference between a simulated formation and a natural formation, a deterioration in quality of a secondary interface due to gas-water back-invasion, difficulty in visually observing the secondary interface, an impact on gas tightness of a device and thus on pressure stabilization due to an arranging manner of sonic logging probes, and difficulty in simultaneously measuring a compressive strength of cement slurry and a shear strength of the secondary interface in the prior art, the present disclosure provides a method and system for cementing simulation and gas-water back-invasion evaluation in complex formations.

The system for cementing simulation and gas-water back-invasion evaluation in complex formations includes a reaction vessel, wherein a simulated formation is provided within a vessel body, a buffer space is provided between the simulated formation and an inner wall of the vessel body, and a cement ring and a casing are provided in sequence within the simulated formation, the three being concentric circular ring columns; a movable bottom plate is provided within the vessel body, a vessel cover and the movable bottom plate seal upper and lower ends of the vessel body, respectively, and the movable bottom plate supports the simulated formation, the cement ring and the casing; an upper end of the casing is in sealed connection with the vessel cover, and a lower end of the casing is in sealed connection with the movable bottom plate;
two groups of hydraulic cylinders are provided below the movable bottom plate, a first group of hydraulic cylinders is placed below the simulated formation, and a second group of hydraulic cylinders is placed below the cement ring;
the casing has a casing cavity, a cement return hole is provided at a lower portion of the casing, and the cement return hole is in communication with a cementing annulus wherein the cement ring is located; sonic logging probes are provided within a reaction vessel; a gas detection device is provided within the reaction vessel, and the gas detection device includes probes for detecting temperature and/or pressure that are distributed in the cement ring, the simulated formation and the buffer space; and the buffer space, the casing cavity, the cementing annulus and the simulated formation are all provided with tubes.

A casing body of the casing has a sandwich, the sonic logging probes are uniformly embedded and distributed within a casing body sandwich of the casing, a sonic logging data line is in signal connection with the sonic logging probes, and the sonic logging data line is placed outside a sandwich of the casing.

An inner wall of the casing is provided with a pressure relief hole at one end close to the vessel cover, and the pressure relief hole communicates the sandwich of the casing with the casing cavity of the casing.

The probes for detecting temperature and/or pressure are one temperature probe, five temperature pressure probes and one pressure probe, the temperature probe is provided within the cement ring, the five temperature pressure probes are provided side by side in the simulated formation, and the pressure probe is provided in the buffer space.

A visualization imaging device is provided within the reaction vessel, the visualization imaging device includes a glass tube and an imaging probe for imaging a secondary interface, two ends of the glass tube are opened, and the glass tube penetrates through the buffer space and the simulated formation, so that an inner port of the glass tube directly faces the secondary interface, and an outer port of the glass tube extends onto the vessel body to be in sealed connection with the vessel body; and the imaging probe is mounted within the glass tube.

The movable bottom plate includes a movable upper plate, a movable lower plate and a central plate which are provided in an embedded manner, the movable upper plate, the movable lower plate and the central plate are combined to form a bottom of the closed vessel body, and a connecting position of the movable upper plate, the movable lower plate and the central plate is filled with a sealed rubber gasket.

Each group of hydraulic cylinders includes two hydraulic cylinders, the first group of hydraulic cylinders is placed below the simulated formation with the secondary interface as a boundary, and two hydraulic cylinders in the first group of hydraulic cylinders are distributed on left and right sides of a lower end of the simulated formation; and the second group of hydraulic cylinders is placed below the cement ring with a primary interface and the secondary interface as boundaries, and two hydraulic cylinders in the second group of hydraulic cylinders are distributed on left and right sides of a lower end of the cement ring.

An inner side wall of the simulated formation is provided with a water-soluble film, and an outer side wall of the simulated formation is provided with a sand-barrier mesh; and a plastic film is adhered to an outer surface of the casing. A rotating shaft is mounted on the vessel body, and the rotating shaft is used for being connected with a rotating device, thereby achieving rotation of the vessel body.

A method for cementing simulation and gas-water back-invasion evaluation in complex formations adopting the above system, including the following steps:
(1) preparation phase:
the simulated formation is prepared in the reaction vessel, and the gas detection device and the visualization imaging device are mounted; the water-soluble film and the sand-barrier mesh are provided;
a porosity of the simulated formation is adjusted until a difference between the porosity of the simulated formation and an “average value of a porosity of a target formation”/the average value of the porosity of the target formation is <10%;
an outside of the casing is coated with petroleum jelly and wrapped with a plastic film, the casing is then mounted on the vessel cover, and the reaction vessel is resealed;
water bath temperature control is performed on the vessel body until temperature of the simulated formation reaches temperature of the target formation;
(2) hydrate generation phase:
methane and pore water are injected into the simulated formation, the reaction vessel is rotated to make distribution of the pore water uniform, and water bath temperature conditions outside the vessel body are kept unchanged until a hydrate is generated;
(3) cementing phase:
after well washing, cement slurry is injected into the casing, the reaction vessel is closed, and the cement slurry is pushed to return back;
pressure of the cement slurry is made higher than pressure of the buffer space by a manner of injecting nitrogen into the simulated formation, and the pressure is maintained until the cement slurry solidifies; and
(4) obtaining of experimental data:
the temperature and pressure within the reaction vessel are obtained through the temperature and/or pressure probes;
the secondary interface is observed through the imaging probe;
after the cement slurry solidifies, the sonic logging probes are started to emit sonic waves, and a receiver obtains the sonic waves; then, the first group of hydraulic cylinders is started to lift the simulated formation, pressure changes of the first group of hydraulic cylinders are recorded; and finally, the second group of hydraulic cylinders is started to compress the cement ring, and pressure changes of the second group of hydraulic cylinders are recorded.

Tubes provided on the buffer space, the casing cavity, the cementing annulus and the simulated formation include: a back-pressure valve interface/gas outlet in communication with the buffer space, an injection port in communication with the casing cavity, a liquid and gas draining port in communication with the cementing annulus, a gas-liquid inlet and a gas-liquid outlet enabling inlet and outlet of gas or liquid in the simulated formation; the gas-liquid inlet penetrates through the vessel cover and extends to the upper end of the simulated formation; and one end of the gas-liquid outlet penetrates through the movable bottom plate to extend to the lower end of the simulated formation.

### Definitions of Terms

Primary interface: In a cementing and completion project, the cementing surface between the casing and the cement ring is referred to as a cementing primary interface. Its cementing quality has a direct impact on the safety and stability of oil and gas wells.

Secondary interface: The cementing surface between the cement ring and the formation is referred to as a cementing secondary interface. The cementing quality of the secondary interface is also critical to the safety and stability of oil and gas wells, the secondary interface can effectively prevent formation fluid channeling, and the importance of the secondary interface is greater than that of the primary interface in quality evaluation.

Gas-water back-invasion: In the cementing process, the phenomenon of formation gas or liquid invasion into the cement ring is referred to as gas-water back-invasion. Gas-water back-invasion can lead to decreased cementing quality and even to safety incidents such as blowouts.

Pore water: Water is injected into the simulated formation, such that it is distributed in the pores of the simulated formation, i.e., pore water.

Hydrate decomposition: Natural gas hydrates decompose upon meeting certain conditions (e.g., reduced pressure and increased temperature) to release gas (e.g., methane, etc.) and water. In deep water drilling, decomposition of natural gas hydrates can have a major impact on drilling safety, for example, increased well hole pressure, wall destabilization, cementing failures and the like are caused.

Natural formations refer to formations where drilling is located during extraction of oil and natural gas. Corresponding to the simulated formation, the simulated formation is used for simulating the natural formations.

The simulated formation means that an actual formation is simulated by mixing and stacking materials such as quartz sand, anhydrous calcium chloride, sodium silicate and sodium bentonite in an experimental device, and the structure formed by these parts of materials is called a simulated formation for evaluation of the interface cementing strength in the laboratory experiment.

Target formations refer to the natural formations to which the evaluation of the interface cementing strength in the laboratory experiment is directed.

Confining pressure generally refers to the pressure exerted on the rock by its surrounding rock mass, but in the present disclosure, confining pressure refers to the adjustment of the gas pressure in a space (referred to as a buffer space) provided at the outer surface of the simulated formation such that the simulated formation is subjected to circumferential pressure.

Downhole in-situ cementing refers to the process of cementing after natural formation drilling.

And/or: A and/or B include/includes A and B, A or B.

In the present disclosure, the sealing connecting position may be performed in a conventional manner such as a sealant, a sealing gasket, and a rubber sealing ring.

Compared with the prior art, the present disclosure at least achieves the following beneficial effects:
1. Non-uniform pore distribution and pressure in the simulated formation caused by pressure generated by the limited thickness of the simulated formation and invasion of cement slurry into the simulated wellbore ring wall, there is a large difference from the natural formation, and the present disclosure makes improvements for these problems to overcome the problems of non-uniform pore distribution and pressure in the simulated formation, make the simulated formation closer to the natural formation, and increase the accuracy of quality evaluation.
2. The present disclosure reduces the impact of non-uniform pore water distribution in the simulated formation caused by the action of gravity on the evaluation accuracy of the cementing quality by rotating the reaction vessel, so that hydrates are uniformly produced, and the evaluation accuracy of the cementing strength and zonal isolation capacity of the secondary interface are increased.
3. To prevent quality deterioration of the secondary interface caused by gas-water back-invasion, in the present disclosure, a gas detection device and a visualization imaging device are added to the system, temperature and pressure changes are detected, and visual imaging is performed, so as to provide more comprehensive index analysis for cementing quality evaluation.
4. The visualization imaging device can achieve real-time observation of a series of processes such as an in-pore hydrate formation process, a process of seepage invasion of cement slurry in formation pores, a process of thermal decomposition of hydrates by hydration, a process of reverse pushing of cement slurry by high pressure gas water generated by hydrate decomposition, and a process of critical state of invasion of high pressure gas water into cement slurry from simulated formation pores, and the problem of difficulty in intuitively observing secondary interface morphological development and fissure development is solved.
5. Decomposition of hydrates in the simulated formation is monitored in real time by the gas detection device to serve as a basis for cementing quality evaluation. The probes are placed at different diameters and depths in the simulated formation, decomposition of hydrates in the simulated formation is determined through temperature and pressure change data, and the gas-water back-invasion index can be evaluated; and the temperature probe placed inside the cement ring can monitor the cement temperature in real time, the pressure probe placed inside the buffer space can monitor the equilibrium pressure in the simulated formation in real time, and the decomposition of hydrates under different cement heat release temperature and pressure conditions can be studied; and the problems of difficulty in evaluating secondary interface cementing strength and zonal isolation capability due to gas-water back-invasion in hydrate-containing formations and low accuracy are solved.
6. By means of the sonic logging probes and the two groups of hydraulic cylinders, sonic logging data and shear compressive strength data are easily and quickly obtained, which solves the problem that an original operating method is high in operating difficulty and easily generates errors; and the compressive strength of the cement slurry and the shear strength of the secondary interface are simultaneously tested, the use of the evaluation system is increased, and the cementing quality are more comprehensively measured and evaluated.
7. The problem that the complex simulated formation cementing process is much different from the actual cementing is solved by setting the buffer space isolated by the sand-barrier mesh inside the reaction vessel, adjusting the gas pressure in the buffer space, and realizing a uniform seepage process of the cement slurry in the pores of the simulated formation, being close to the downhole in-situ cementing process, and having higher accuracy.

### BRIEF DESCRIPTION OF THE DRAWINGS

FIG. 1 is a cross-sectional view of a system for cementing simulation and gas- water back-invasion evaluation in complex formations;

FIG. 2 is a top view of the system for cementing simulation and gas-water back-invasion evaluation in complex formations;

FIG. 3 is a structural schematic view of a movable bottom plate;

FIG. 4 is an embedding (explosion) schematic view of a sonic logging probe;

FIG. 5 is an embedding partial schematic view (cross-sectional view) of the sonic logging probe;

FIG. 6 is a schematic view of an arrangement of a gas detection device;

FIG. 7 is a side view of the system for cementing simulation and gas-water back-invasion evaluation in complex formations;

reference numerals: 1, rotating shaft; 2, back-pressure valve interface/gas outlet; 3, gas-liquid outlet; 4, connecting nut; 5, gas-liquid inlet; 6, hydraulic cylinder; 601, first group of hydraulic cylinders; 602, second group of hydraulic cylinders; 7, liquid and gas draining port; 8, gas detection device connecting port; 801, temperature probe; 802, temperature pressure probe; 803, pressure probe; 9, simulated formation; 10, cement ring; 11, glass tube; 12, imaging probe; 13, buffer space; 14, water-permeable bottom plate; 15, casing; 16, sonic logging probe; 17, injection port; 18, sonic logging data line; 19, vessel cover; 20, rubber sealing ring; 21, sand-barrier mesh; 22, water-soluble film; 23, vessel body; 24, casing cavity; 25, movable bottom plate; 2501, movable upper plate; 2502, movable lower plate; 2503, central plate; 2504, sealed rubber gasket; 26, pressure relief hole; 27, cement return hole; 28, screw sealed connecting device; 29, primary interface; 30, secondary interface.

### DETAILED DESCRIPTION OF THE EMBODIMENTS

In order to make the objectives, technical solutions and advantages of the present disclosure clearer and more comprehensible, the present disclosure is described in further detail below with reference to the embodiments.

### Embodiment 1 A System for Cementing Simulation and Gas-Water Back-Invasion Evaluation in Complex Formations

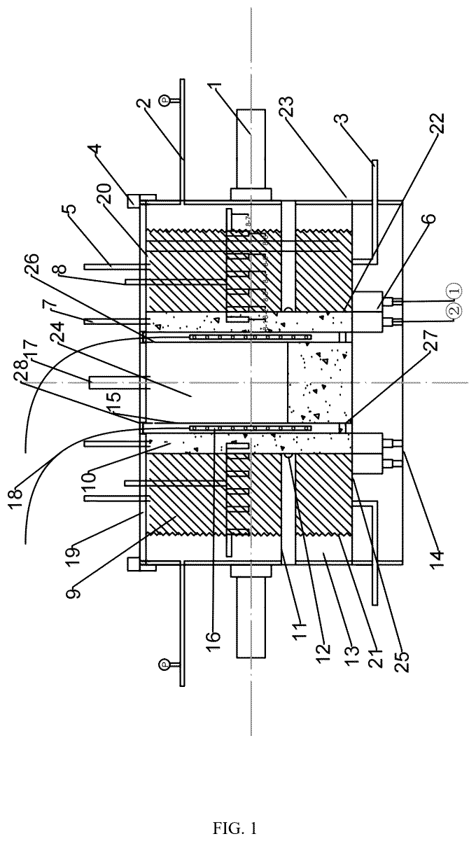

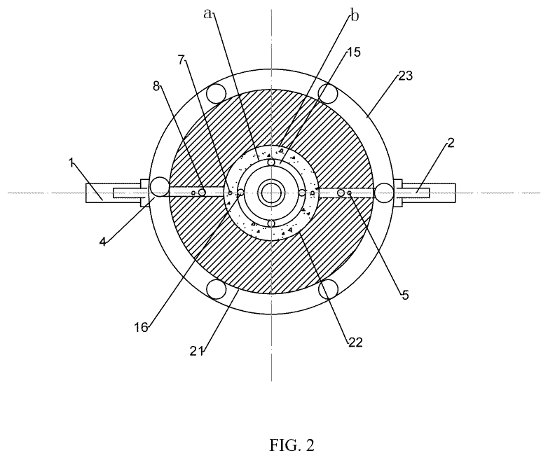

As shown in FIG. 1 and FIG. 2, the system for cementing simulation and gas- water back-invasion evaluation in complex formations (abbreviated as the evaluation system) includes a reaction vessel, the reaction vessel includes a vessel body 23, a vessel cover 19 and a movable bottom plate 25, the vessel body 23 has a cavity therein, the vessel body 23 is used for housing a reaction main body of the whole system to be connected with other auxiliary devices; optionally, the cross-section of the vessel body is circular, square or rectangular, preferably circular; rotating shafts 1 are installed on both sides of the vessel body 23 for being connected with rotating devices, thereby achieving rotation of the vessel body; and the top of the vessel body 23 is provided with the vessel cover 19, a rubber sealing ring 20 is placed within the vessel cover 19 to seal the vessel body 23, and the vessel cover 19 is connected to the vessel body 23 by means of six connecting nuts 4 evenly distributed along a circumferential direction. An injection port 17 is provided on the vessel cover 19, the injection port 17 is used for injecting cement slurry into a casing cavity 24 of the casing 15 within the vessel body, after injection of the cement slurry, the injection port 17 is connected to a high-pressure gas pump to inject high-pressure gas (also referred to as posterior gas) into the casing cavity 24 to pressurize the cement slurry, so that the cement slurry returns back into the cementing annulus, and the cement ring 10 is formed after the cement slurry solidifies in the cementing annulus.

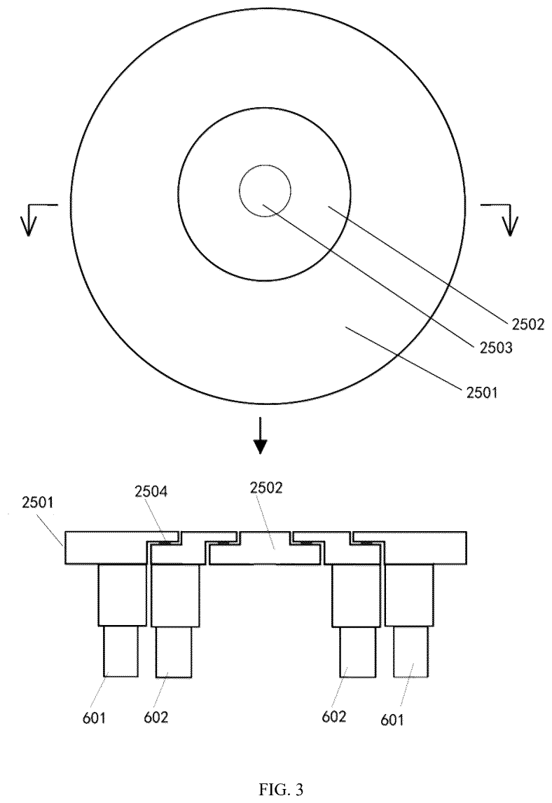

The movable bottom plate 25 is provided in the bottom of the vessel body 23 in a sliding sealing manner, and the movable bottom plate 25 is slidably connected to the inner wall of the vessel body 23, so that the movable bottom plate 25 slides up and down by a certain distance within the vessel body; and the movable bottom plate 25 and the inner wall of the vessel body 23 are sealed to prevent pressure release. As shown in FIG. 3, the movable bottom plate 25 includes a movable upper plate 2501, a movable lower plate 2502, a central plate 2503 and a sealed rubber gasket 2504, the movable upper plate 2501, the movable lower plate 2502 and the central plate 2503 are combined together to form the bottom of the closed vessel body 23, for example, when the vessel body 23 is circular, the movable upper plate 2501 and the movable lower plate 2502 are both in circular rings nested inside and outside, the central plate 2503 is circular, and the three are combined to form a complete circle; sides of the movable upper plate 2501 and the movable lower plate 2502 that are connected are provided with steps, respectively, the sides of the movable lower plate 2502 and the central plate 2503 that are connected are provided with steps, respectively, the steps are buckled together when the three are combined, positions between the steps of the movable upper plate 2501 and the movable lower plate 2502 are filled with the sealed rubber gasket 2504, and positions between the steps of the movable lower plate 2502 and the central plate 2503 are filled with the sealed rubber gasket 2504, so that the three form a complete sealing structure when there is no movement, and no leakage of gas or cement slurry occurs between the steps of the movable upper plate 2501, the movable lower plate 2502 and the central plate 2503. The movable bottom plate 25 is located at the bottom ends of the simulated formation 9, the casing 15 and the cement ring 10 to support the three.

As shown in FIG. 1, the bottom of the vessel body 23 is fixedly provided with a water-permeable bottom plate 14, and the water-permeable bottom plate 14 supports the hydraulic cylinders. Two groups of hydraulic cylinders 6 (a first group of hydraulic cylinders 601 and a second group of hydraulic cylinders 602) are provided between the movable bottom plate 25 and the water-permeable bottom plate 14, each group of hydraulic cylinders includes two hydraulic cylinders, a first group of hydraulic cylinders 601 is placed below the simulated formation 9 with the secondary interface 30 between the cement ring 10 and the simulated formation 9 as a boundary, the first group of hydraulic cylinders 601 is distributed on both left and right sides of the lower end of the simulated formation 9, i.e., piston rods of the first group of hydraulic cylinders 601 move upward to directly lift the simulated formation 9 located at the secondary interface 30, and the first group of hydraulic cylinders 601 lifts the simulated formation 9 upward to achieve detection of shearing of the secondary interface; and since the simulated formation is a circular ring column, the bottom surface of which is a circular ring, the two cylinders in the first group of cylinders 601 are distributed on the same diametrical line on a bottom surface of the simulated formation, so that when the simulated formation 9 is lifted upwards by the first group of cylinders 601, forces on the left and right sides of the simulated formation 9 are relatively uniform. A second group of hydraulic cylinders 602 is placed below the cement ring 10 with a primary interface 29 formed by the casing 15 and the cement ring 10 and a secondary interface 30 formed between the cement ring 10 and the simulated formation 9 as boundaries, the second group of hydraulic cylinders 602 is distributed on both left and right sides of the lower end of the cement ring 10, i.e., piston rods of the second group of hydraulic cylinders 602 are moved upward to lift the entire cement ring directly, and the second group of hydraulic cylinders 602 lifts the cement ring upward, so that the upper end of the cement ring is extruded by the vessel cover to achieve compression detection of the cement ring 10. Since the cement ring is a circular ring column and the bottom surface of the cement ring is a circular ring, the two hydraulic cylinders in the second group of hydraulic cylinders 602 are distributed on the same diametrical line on the bottom surface of the cement ring 10, so that when the second group of hydraulic cylinders 602 lifts the cement ring upward, forces on the left and right sides of the cement ring 10 are relatively uniform.

The simulated formation 9 is provided within the vessel body 23, and the simulated formation is used for simulating the actual natural formation, i.e. the target formations. The simulated formation 9 is a circular ring column, and a cavity inside the simulated formation 9 is a simulated wellbore. There is an annular space between the simulated formation 9 and the inner wall of the vessel body 23, which is referred to as a buffer space 13, preferably a height of the buffer space 13 is equal to a height of the simulated formation 9. The vessel body 23 is provided with a back-pressure valve interface/gas outlet 2 to be in communication with the buffer space 13 for injecting gas into the buffer space 13 or releasing pressure from the buffer space 13, thereby regulating confining pressure to solve the problem of non-uniform pore distribution and pressure of the simulated formation 9 caused by invasion of the cement slurry into the simulated formation 9. The pressure of the buffer space is controlled to achieve a uniform seepage process of the cement slurry in the pores of the simulated formation, making the evaluation process closer to the downhole in-situ cementing process, enabling the accuracy to be higher, and reducing the impacts of pressure building, local pressure non-uniformity, excessive local pressure and the like generated by the evaluation system itself on the seepage of the cement slurry in the formation pores. The back-pressure valve interface/gas outlet 2 can be provided with a filter device (not shown in the figure) to avoid clogging of the back-pressure valve interface/gas outlet 2 and impacts of sand particles on the sealing property of a back-pressure valve, the filter device is provided within the buffer space and is not in direct contact with the simulated formation to improve the effect and extend the life, and the filter device adopts a quick disassembly structure, a filter screen and a filter element to achieve quick replacement.

The cement ring 10 is provided within a simulated wellbore, one side of the simulated formation 9 that is close to the cement ring 10 is an inner side of the simulated formation 9, an inner side wall of the simulated formation 9 is a simulated wellbore ring wall, the simulated wellbore ring wall is provided with a water-soluble film 22, the water-soluble film 22 will gradually dissolve when meeting with water, so when the cement slurry is in contact with the water-soluble film, it will cause the dissolution of the water-soluble film 22, and part of the cement slurry will invade into the simulated formation 9; and one side of the simulated formation 9 that is close to the vessel body 23 is an outer side of the simulated formation 9, the outer side wall of the simulated formation 9 is provided with a sand-barrier mesh 21, and both the water-soluble film 22 and the sand-barrier mesh 21 are used for ensuring that a soil mass inside the simulated formation 9 is stable against collapse before the simulated formation 9 is combined with cement by reactions.

The casing 15 is also provided within the simulated wellbore, the casing 15 is tubular, is opened at both upper and lower ends, and forms a casing cavity 24 inside; the casing 15, the cement ring 10 and the simulated formation 9 are the same in height, the three are concentric circular ring columns, and cross-sections of the three are concentric circular rings; prior to injection of cement, the cement ring 10 has not been formed, in this case, an annular cavity is formed between the casing 15 and the simulated wellbore ring wall, which is referred to as the cementing annulus, after the cement slurry is injected from the casing cavity of the casing 15 and returned back in the cementing annulus (return refers to flow from bottom to top), the cement slurry in the cementing annulus gradually solidifies to form the cement ring 10, an interface where the cement ring 10 is in contact with the casing 15 is a primary interface 29, an interface where the cement ring 10 is in contact with the simulated formation 9 is a secondary interface 30, a plastic film is provided at the primary interface 29 of the casing 15 (i.e., the outer surface of the casing), the plastic film is adhered to the casing 15 through petroleum jelly, and the plastic film at the primary interface 29 enables the primary interface between the casing 15 and the cement ring 10 to have almost no shear force when the cement ring 10 is forced to move upward. The casing 15 has external threads at both upper and lower ends, a screw sealed connecting device 28 is provided on the vessel cover 19 corresponding to the position of the upper end portion of the casing 15, the screw sealed connecting device 28 has internal threads, the central plate 2503 corresponding to the position of the lower end portion of the casing 15 has internal threads, the upper end of the casing 15 is in sealed connection with the vessel cover 19 by screw fitting, the lower end of the casing 15 is in sealed connection with the central plate 2503, and four cement return holes 27 are circumferentially distributed on the casing wall near the movable bottom plate 25 for cement returning. The four cement return holes 27 are evenly spaced and distributed on the casing wall at an equal distance from the movable bottom plate, thus facilitating even returning of the cement slurry in the whole cementing annulus. The injection port 17 rightly faces the casing cavity 24 of the casing 15, such that the cement slurry is first injected into the casing cavity 24 and then into the cementing annulus through the cement return holes 27.

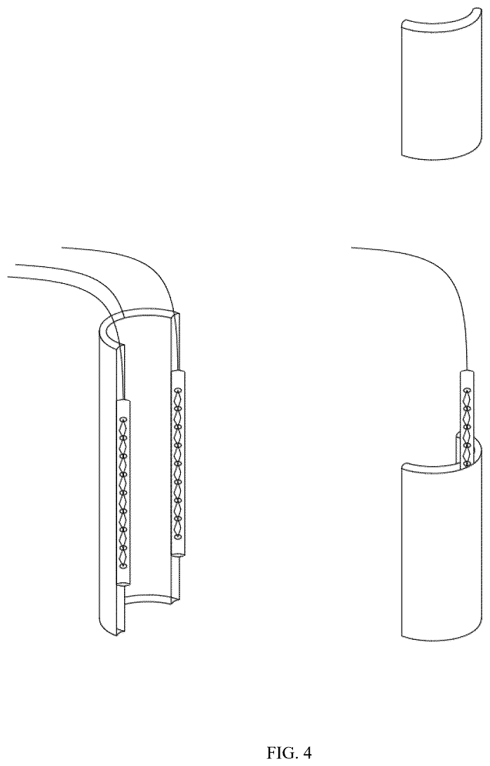

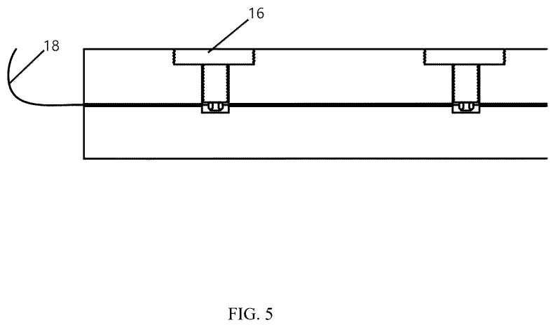

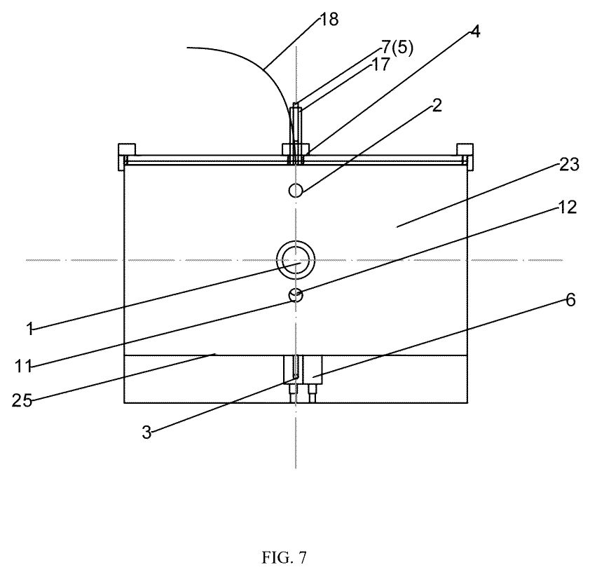

As shown in FIG. 4 and FIG. 5, the center of the casing 15 is provided with a cylindrical casing cavity 24 for injecting the cement slurry, a casing body of the casing 15 has a sandwich, the sandwich refers a space formed between an inner wall and an outer wall of the casing body, sonic logging probes 16 are uniformly embedded and distributed within the casing body sandwich of the casing 15, a sonic logging data line 18 is in signal connection with the sonic logging probes 16, and the sonic logging data line 18 is placed outside the sandwich of the casing 15. Such an arrangement manner can solve the problem that the sonic logging probes 16 and their data line are difficult to place after the vessel cover is sealed, and the sonic logging probes 16 are used for sonic detection of the quality of the cement ring. As shown in FIG. 7, a plurality of sonic logging probes 16 are connected in parallel to be connected with the sonic logging data line 18 to form a group of sonic logging probes, and data is transmitted through the sonic logging data line 18. The arrangement manner of the embedded sonic logging probes mainly considers that after the posterior gas is pushed, it conflicts with the sonic logging probes provided inside the casing cavity, the sealing conditions within the reaction vessel body are very vulnerable when the sonic logging probes are placed directly within the casing cavity 24, the sonic logging probes are then embedded inside a casing jacket, the data in the sonic logging probes is derived for analysis using the data line, and a group of sonic logging probes is embedded inside the casing every 90°, four groups of sonic logging probes are annularly distributed, and a complete sonic logging system is formed by 360° full coverage. The sonic logging probes are quickly detachable and sealed from the outer wall of the casing. Detection of cementing situations of the cement ring at different hydration ages is achieved, and sonic data is returned for analysis of cementing quality of the cement ring. The design strength of the casing meets the impacts on the strength testing processes of the cementing primary and secondary interfaces and the cement ring. A line hole is provided in the vessel screw sealed connecting device 28 to allow connections of the sonic logging data line 18 with the sonic logging probes within the vessel body, and the screw sealed connecting device 28 and the sonic logging data line 18 are sealed.

As shown in FIG. 1, the inner wall of the casing 15 is provided with a slight pressure relief hole 26 at an end close to the vessel cover 19, and the pressure relief hole 26 communicates the casing body sandwich of the casing 15 with the casing cavity 24 to equalize the extrusion impacts of pressure intensity inside the vessel body against the sandwich of the casing 15. Since the pressure relief hole 26 is close to the vessel cover 19 and is provided at a high position, the cement slurry does not cause clogging of the pressure relief hole 26 when the cement slurry is injected into the casing 15, and the cement slurry also cannot enter the sandwich of the casing 15 from the pressure relief hole 26.

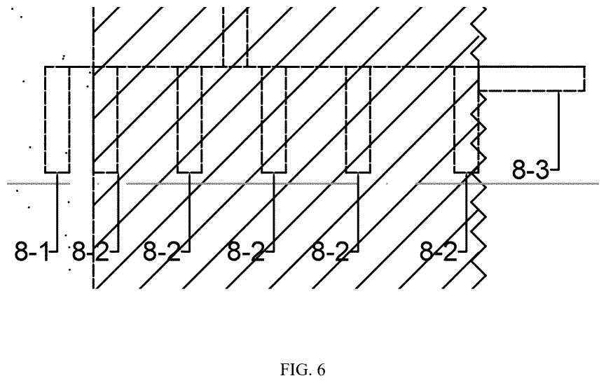

As shown in FIG. 6, the evaluation system also includes a gas detection device and a visualization imaging device for back-invasion monitoring. The gas detection device includes seven probes (a temperature probe 801, five temperature pressure probes 802 and a pressure probe 803), wherein the temperature probe 801 is provided inside the cement ring, the five temperature pressure probes 802 are provided side by side in the simulated formation 9, and the pressure probe 803 is provided in the buffer space 13; the visualization imaging device includes a glass tube 11 and an imaging probe 12, the glass tube 11 is opened at both ends, and the glass tube 11 penetrates the buffer space 13 and the simulated formation 9, such that an inner port of the glass tube 11 faces the secondary interface 30, an outer port of the glass tube extends onto the vessel body 23 to be in sealed connection with the vessel body 23, the glass tube 11 forms a visualization window, and changes of the simulated formation can be directly observed with naked eyes; and the imaging probe 12 is mounted at the inner end of the glass tube 11 that is close to the secondary interface 30 to achieve visual imaging of the secondary interface 30. The visualization imaging device goes deep inside the simulated formation, reaches the secondary interface, and is fitted with imaging probes of different accuracies to achieve real-time observation of a series of processes such as an in-pore hydrate formation process of the simulated formation, a process of seepage invasion of cement slurry in formation pores, a process of thermal decomposition of hydrates by hydration, a process of reverse pushing of cement slurry by high pressure gas water generated by hydrate decomposition, and a process of critical state of invasion of high pressure gas water into cement slurry from simulated formation pores. The prior art mainly determines the critical conditions of high-pressure gas-water back-invasion of the cement slurry through numerical simulation methods, whereas experiment-based studying methods are few and currently not found to be achieved by visual means of direct observation. The inner and outer surfaces of the glass tube 11 in the evaluation process of the present disclosure may be sprayed with an anti-fogging solution to avoid hydrate agglomeration and generation at the interface, and the major components of the anti-fogging solution do not affect the hydrate phase balance. In the present disclosure, the imaging probe is placed directly at the secondary interface, and the placement of the imaging probe is achieved by the glass tube; and the glass tube is in soft sealed connection (e.g., rubber seal) with the vessel body, and a distance that the simulated formation lifted by the cylinder is small, so that the cylinder does not damage the glass tube. For the gas detection device, the temperature pressure probes are placed at different diameters and depths in the simulated formation, decomposition of hydrates in the simulated formation is determined through temperature and pressure change data, and the gas-water back-invasion index can be evaluated; and the temperature probe placed inside the cement ring can monitor the cement temperature in real time, the pressure probe placed inside the buffer space can monitor the equilibrium pressure in the simulated formation in real time, and the decomposition of hydrates under different cement heat release temperature and pressure conditions can be studied.

As shown in FIG. 1 and FIG. 7, the upper portion of the vessel body 23 is provided with a gas-liquid inlet 5, and the gas-liquid inlet 5 penetrates through the vessel cover and extends to the upper end of the simulated formation 9; the lower portion of the vessel body 23 is provided with a gas-liquid outlet 3, the gas-liquid outlet 3 is a telescopic tube, one end of the gas-liquid outlet 3 penetrates through the movable bottom plate 25 to extend to the lower end of the simulated formation 9, and the gas-liquid inlet 5 is directly above the gas-liquid outlet 3; the gas-liquid inlet 5 may be used for injecting methane and pore water into the simulated formation to generate hydrates in the simulated formation, and excess methane and pore water are drained from the gas-liquid outlet 3 at the lower portion; in addition, the pore pressure in the simulated formation is adjusted by injecting high-pressure nitrogen into the simulated formation through the gas-liquid inlet 5 such that the cement slurry pressure is only slightly higher than the pore pressure of the simulated formation (the pressure in the buffer space detected by the pressure probe 803 represents the pore pressure of the simulated formation) until the cement slurry sufficiently solidifies. A liquid and gas draining port 7 is provided at the upper portion of the vessel body 23, and one end of the liquid and gas draining port 7 is derived into the cementing annulus to be primarily used for the circulation drainage of cement slurry. The liquid and gas draining port 7 may adopt a tube, an outer end of which is provided with threads, and a threaded hole is provided on the vessel cover 19, and the liquid and gas draining port 7 penetrates through the vessel cover and is in threaded connection with the vessel cover. The gas-liquid inlet 5 is in sealed connection with the vessel cover 19 by adopting the same manner. After injection of the cement slurry into the casing cavity 24, high-pressure gas is injected into the casing cavity through the injection port 17, the high-pressure gas causes the cement slurry to return in the cementing annulus, in the returning process, the gas in the cementing annulus is drained through the liquid and gas draining port 7, and after returning is completed, excess cement slurry is drained through the liquid and gas draining port 7. In addition, drilling fluid generated during well washing is also drained from the liquid and gas draining port 7.

The evaluation system requires the cooperation of a water bath thermostat and a rotating device (both not shown in the figure), and the temperature of the evaluation system is controlled by placing the entire evaluation system in the water bath thermostat; and the vessel body 23 is connected to the rotating device through the rotating shaft 1, so that the rotating device drives the vessel body 23 to rotate for the purpose of rotating the simulated formation 9, and rotation enables the distribution of pore water in the simulated formation 9 to be uniform. The rotating device may adopt any existing device capable of being connected with the rotating shaft 1 and driving the vessel body 23 to rotate.

The evaluation system performs evaluation of the cementing strength mainly by two groups of hydraulic cylinders, and one group is placed below the simulated formation with the secondary interface between the cement ring and the simulated formation as a boundary for shearing the secondary interface to evaluate the cementing strength of the secondary interface; the other group is placed below the cement ring with the primary interface and the secondary interface formed by the casing and the cement ring as boundaries for compressing the cement ring to evaluate the compressive strength of the cement ring; and typically, the secondary interface is sheared before the hydraulic cylinders rise and compress the cement ring. The evaluation system not only comprehensively evaluates the cementing strength of the cementing secondary interface and the compressive strength of the cement ring, but also achieves the test under temperature and pressure conditions simulating the downhole in-situ formation, so that the results are more in line with reality, and can more accurately reflect the actual cementing quality than the results of the test carried out at room temperature and ordinary pressure.

### Embodiment 1 Cementing of Formation Without Hydrates

Experimental steps of cementing of formation without hydrates:

To reduce experimental variables, when the cement slurry is prepared, it is ensured that stirring time for solid-liquid mixing and rotational speed are consistent for each experiment.
(0) Selection of Target Formation:

The Pearl River Mouth Basin Baiyun Sag GMGS3-W19 site is selected as a target well, a hydrate formation in the well is selected as a target layer, and it can be known by results of logging and downhole in-situ target formation core testing that a water depth of the site is 1273.6 m and the subsea temperature is about 4° C. The main constituents of the hydrate formation are quartz sand and clay fine grain sediments, the hydrate layer temperature is 14.46° C., the formation pressure is 14.68 MPa, and the average value of the porosity is 0.4.
(1) Preparation Phase:

Scaffold materials are prepared. According to test data of downhole in-situ target formation coring, natural quartz sand with matched particle sizes is selected as a porous medium of a simulated formation scaffold; according to the previous experimental effect, the natural quartz sand having a particle size of 10-60 meshes is selected, followed by washing the natural quartz sand with distilled water for 2-3 times until no impurities are apparent in the water, and finally drying treatment is performed to obtain the simulated formation scaffold material.

A simulated formation is prepared. Quartz sand washed to be clean, anhydrous calcium chloride, sodium silicate and sodium bentonite are divided into three parts on average according to the required mass and stirred uniformly, and then added into a reaction vessel at three times and sequentially; the present disclosure simulates a clay fine grain sediment in an in-situ formation with sodium bentonite using montmorillonite as a main ingredient; in the process of being added into the reaction vessel, the gas detection device and the visualization imaging device are mounted, and finally the pressure is uniformly applied along the axial direction of the reaction vessel and maintained for the desired time; and in the preparation process, the simulated formation 9 can be prepared by batch charging and pressing a plurality of times to improve the uniformity of the pores and to roughen the joint surface at the adjacent filling times.

Physical property (porosity of simulated formation) testing is performed. The porosity of the simulated formation is tested by the drainage method, and when the average values of the porosity of the simulated formation and the porosity of the target formation are similar (similar means that a difference between the porosity of the simulated formation and the “average value of the porosity of the target formation” average value of the porosity of the target formation is <10%), it indicates that the simulated formation 9 coincides with the target formation in operating conditions; and when the simulated formation 9 coincides with the target formation in operating conditions, the next operation is performed. If not, pressure is uniformly applied along the axial direction of the reaction vessel to adjust the porosity of the simulated formation until coinciding is achieved.

Gas tightness check of the reaction vessel is performed. A water-soluble film 22 is provided on an inner side of the simulated formation 9 and a sand-barrier mesh 21 is provided on an outer side thereof to prevent damage to the simulated formation and to prevent invasion of sand into the buffer space 13. Next, the rubber sealing ring 20 is mounted on the vessel cover 19 and a contact area of the vessel cover is pretensioned to ensure that the height of the simulated formation 9 is not below the lower edge of the rubber sealing ring 20 above, the reaction vessel is sealed with the vessel cover 19, and pre-tensioning manners include, but are not limited to, pressing the upper end of the simulated formation 9 by hand or by an article. The inside of the reaction vessel is filled with nitrogen to 15 MPa and held at a pressure for 12 hours, whether the pressure of the reaction vessel changes or not is observed, and if there is no change, the gas tightness of the reaction vessel is good. If a significant change in pressure is observed, it is indicated that the gas tightness of the reaction vessel is poor, and the reaction vessel needs to be resealed until the gas tightness of the reaction vessel is good.

Temperature of the target formation is simulated and maintained. After the simulated formation 9 passes the physical property test and the reaction vessel passes the gas tightness check, the vessel cover 19 is mounted and the casing 15 is mounted onto the vessel cover 19, and the vessel cover 19 and the vessel body 23 are fastened by a connecting nut 4. The outside of the casing 15 is first coated with a sufficient amount of petroleum jelly and then tightly wrapped with a plastic film to reduce friction between the primary interface 29 and the cement ring 10 to completely separate the cement ring 10 from the casing 15 at a subsequent shearing stage, and the primary interface has almost no shear force. Then, the vessel body 23 is mounted on the rotating device through the rotating shaft 1, and the water bath thermostat is lifted to flood the reaction vessel. The temperature probe in the reaction vessel monitors the temperature of the simulated formation 9 in real time; and when the temperature of the simulated formation reaches the temperature condition (i.e., 4° C.) of the target formation, the next operation is performed.
(2) Cementing phase:

Cement slurry is prepared. The cement slurry required for experiments is prepared according to the operating specifications of the Specification “Test Method for Oil Well Cement” (GB/T19139-2012).

Overbalance cementing is performed. The prepared cement slurry is injected into the casing 15 through a cement pumping machine up to the top of the casing cavity, and the injection time and rate are strictly controlled. Overbalanced cementing (the pressure of the cement slurry is slightly greater than the pressure of the buffer space 13) is employed in the whole injection and pressure maintaining process; and after the cementing cement slurry is fully injected, a certain cementing pressure differential is still maintained, causing the cement slurry to invade the simulated wellbore ring wall slightly. High-pressure nitrogen is injected into the simulated formation through the gas-liquid inlet 5, and high-pressure nitrogen is injected into the buffer space 13, such that the pressure of the cement slurry is only slightly higher than the pore pressure of the simulated formation (the pressure of the buffer space 13 represents the pore pressure of the simulated formation, and the difference between the pressure of the cement slurry and the pore pressure of the simulated formation is less than or equal to 1 MPa, as follows) until the cement slurry sufficiently solidifies.

The temperature and pressure conditions of the simulated formation are maintained. Based on the pressure data obtained by the temperature pressure probe 802 in the simulated formation 9 and the pressure probe 803 in the buffer space 13, the gas pressure in the buffer space 13 is momentarily focused and adjusted in time to balance the cementing differential pressure generated by the invasion of the cement slurry into the simulated wellbore ring wall in the cementing and pressure maintaining process. The temperature and pressure conditions of the simulated formation within the reaction vessel are kept unchanged in the whole experimental process.

After-treatment is performed. After the injection of cement slurry is completed, the reaction vessel is quickly closed. Since the initial setting time of the prepared cement slurry is short, in order to ensure that the system is not damaged after the test is completed, the following procedures need to be completed: the cement pumping machine is shut down and a high-pressure gas pump is connected to the injection port 17, and high-pressure gas is pumped into the casing cavity of the casing to push the cement slurry to return back and remove the residual cement slurry from the casing wall.
(3) Experiments and Analysis of Results:

The invasion amount of cement slurry is observed in real time. The change in the morphology of the cementing secondary interface and the extent of invasion of the cement slurry into the simulated wellbore ring wall can be observed in real time through the imaging probe 12 in a window of the glass tube 11 in the cement solidification process. The interior of the simulated formation can be directly observed through the tube wall of the glass tube 11.

The temperature and pressure changes of the simulated formation are observed in real time. In the cementing process of the simulated formation 9, the temperature and pressure changes of the simulated formation 9 and the cement ring 10 are monitored in real time by the gas detection device, and this data is compared experimentally and can also be used as the cementing quality evaluation standard.

Sonic logging is performed. After the cement slurry sufficiently solidifies, the sonic logging probes embedded in the casing 15 are started to transmit sonic waves, and the receiver converts the sonic waves at different frequencies into data, and through the data analysis, the cementing quality of the secondary interface can be obtained.

In-situ testing of the cementing strength of the secondary interface is performed. The first group of hydraulic cylinders 601 is started to lift the simulated formation 9 at a uniform velocity of 0.5 mm/s, the pressure changes of the first group of hydraulic cylinders 601 are recorded, and the shear strength is calculated; the first group of hydraulic cylinders is returned to the original positions, the first group of hydraulic cylinders 601 is restarted to lift the simulated formation 9 at a uniform velocity of 0.5 mm/s, the pressure changes of the first group of hydraulic cylinders 601 are recorded, and the shear strength is calculated; and the two shear strengths are compared, and the difference between the two shear strengths is the cementing strength of the secondary interface.

In-situ testing of the compressive strength of the cement ring is performed. After the shearing of the secondary interface is completed, the cement ring 10 is completely detached from both sides (due to the action of the petroleum jelly and the plastic film, the primary interface can be approximately regarded as having no shear force between the primary interface and the cement ring 10, i.e. the primary interface is originally detached from the cement ring), the second group of hydraulic cylinders 602 is started to lift the cement ring 10 at a constant velocity of 0.5 mm/s so that the cement ring is compressed by the vessel cover, the pressure changes of the second group of hydraulic cylinders 602 are recorded, and the compressive strength of the cement ring 10 is calculated.

Pressure relief and cleaning are performed. After the completion of the experiments, the confining pressure in the buffer space 13, the pressure inside the vessel body and the hydraulic pressure of the hydraulic cylinders 6 are released, the vessel cover 19 is opened, and the simulated formation 9 and the cement ring 10 are removed.

Experimental results are analyzed.

### Embodiment 2 Cementing of Formation With Hydrates

### Experimental Steps of Cementing of Formation With Hydrates:

In order to reduce experimental variables, the initial temperature and pressure conditions, the methane input rate and the length of the reaction are accurately controlled to ensure the consistent synthesis number of hydrates during the hydrate synthesis experiment; and when the cement slurry is prepared, it also needs to ensure that the stirring time for solid-liquid mixing and rotational speed are consistent.
(0) Selection of target formation:

The Pearl River Mouth Basin Baiyun Sag GMGS3-W19 site is selected as a target well, a hydrate formation in the well is selected as a target layer, and it can be known by results of logging and downhole in-situ target formation core testing that a water depth of the site is 1273.6 m and the subsea temperature is about 4° C. The main constituents of the hydrate formation are quartz sand and clay fine grain sediments, the hydrate layer temperature is 14.46° C., the formation pressure is 14.68 MPa, and the average value of the porosity is 0.4.
(1) Preparation phase:

Scaffold materials are prepared. According to test data of downhole in-situ target formation coring, natural quartz sand with matched particle sizes is selected as a porous medium of a simulated formation scaffold; according to the previous experimental effect, the natural quartz sand having a particle size of 10-60 meshes is selected, followed by washing the natural quartz sand with distilled water for 2-3 times until no impurities are apparent in the water, and finally drying treatment is performed to obtain the simulated formation scaffold material.

A simulated formation is prepared. Anhydrous calcium chloride, sodium silicate and sodium bentonite as well as quartz sand washed to be clean are divided into three parts on average according to the required mass and stirred uniformly, and then added into a reaction vessel at three times; the present disclosure simulates a clay fine grain sediment in an in-situ formation with sodium bentonite using montmorillonite as a main ingredient; in the process of being added into the reaction vessel, the gas detection device and the visualization imaging device are mounted, and finally the pressure is uniformly applied along the axial direction of the reaction vessel and maintained for the desired time; and in the preparation process, the simulated formation 9 can be prepared by batch charging and manual pressing a plurality of times to improve the uniformity of the pores and to roughen the joint surface at the adjacent filling times.

Physical property (porosity of simulated formation) testing is performed. The porosity of the simulated formation is tested by the drainage method, and when the average values of the porosity of the simulated formation and the porosity of the target formation are similar (similar means that a difference between the porosity of the simulated formation and the “average value of the porosity of the target formation” average value of the porosity of the target formation is <10%), it indicates that the simulated formation 9 coincides with the target formation in operating conditions; and when the simulated formation 9 coincides with the target formation in operating conditions, the next operation is performed. If not, pressure is uniformly applied along the axial direction of the reaction vessel to adjust the porosity of the simulated formation until coinciding is achieved.

Gas tightness check is performed. A water-soluble film 22 is provided on an inner side of the simulated formation 9 to prevent damage to the formation, and a sand-barrier mesh 21 is provided on an outer side thereof to prevent damage to the formation and to prevent sand from intruding into the buffer space 13. Then, the rubber sealing ring 20 is mounted on the vessel cover 19 and a contact area is pretensioned to ensure that the height of the simulated formation 9 is not below the lower edge of the rubber sealing ring 20 above. The inside of the reaction vessel is filled with nitrogen to 15 MPa and held at a pressure for 12 hours, whether the pressure of the reaction vessel changes or not is observed, and if there is no change, the gas tightness of the reaction vessel is good. Nitrogen is released after the gas tightness is good, and the nitrogen in the reaction vessel is drained by injecting 2 MPa of methane.

Temperature of the target formation is simulated and maintained. After the simulated formation 9 passes the physical property test and the gas tightness check, the vessel cover 19 is mounted and the casing 15 is mounted onto the vessel cover 19, and the vessel cover 19 and the vessel body 23 are fastened by a connecting nut 4 Up. The outside of the casing 15 is first coated with a sufficient amount of petroleum jelly and then tightly wrapped with a plastic film to reduce friction between the primary interface 29 and the cement ring 10 to completely separate the cement ring 10 from the casing 15 at a subsequent shearing stage, and the primary interface has no shear force. Then, the vessel body 23 is placed on the rotating device through the rotating shaft 1, and the water bath thermostat is lifted to flood the reaction vessel. The temperature probe in the reaction vessel monitors the temperature of the simulated formation 9 in real time; and when the temperature of the simulated formation reaches the temperature condition (i.e., 4° C.) of the target formation, the next operation is performed.
(2) Hydrate generation phase:

Water and methane are injected. When the temperature of the simulated formation reaches 2° C., methane is injected through the gas-liquid inlet 5 to bring the internal pressure of the reaction vessel to 8 MPa, and pore water (500 ml) is added by submersion and drainage methods. Then, the reaction vessel is slowly rotated by the rotating device to distribute the pore water uniformly to reduce the effect of gravity on the distribution of pore water. The reaction vessel is closed, the bath temperature conditions outside the vessel body are kept unchanged, after waiting for the temperature and pressure inside the reaction vessel to stabilize, the generation of hydrates is deemed complete, and the pore pressure and temperature of the simulated formation are then adjusted to 14.68 MPa and 14.46° C., respectively, which are the same as those of the in-situ hydrate formation.
(3) Cementing phase:

The well washing procedure is performed. The prepared drilling fluid is pumped into the casing through the injection port 17, and the injection time and rate are strictly controlled. After the well washing procedure using the drilling fluid is completed, the injection port 17 is pressurized to discharge the drilling fluid from the liquid and gas draining port 7 at a uniform rate according to the injection rate.

Cement slurry is prepared. The cement slurry required for experiments is prepared according to the operating specifications of the Specification “Test Method for Oil Well Cement” (GB/T19139-2012).

Overbalance cementing is performed. The prepared cement slurry is injected into the casing 15 through a cement pumping machine up to the top of the casing cavity, and the injection time and rate are strictly controlled. Overbalanced cementing is employed in the whole injection and pressure maintaining process; and after the cementing cement slurry is fully injected, a certain cementing pressure differential is still maintained, causing the cement slurry to invade the simulated wellbore ring wall slightly. High-pressure nitrogen is injected through the gas-liquid inlet 5, such that the pressure of the cement slurry is only slightly higher than the pore pressure of the simulated formation until the cement slurry sufficiently solidifies.

The temperature and pressure conditions of the simulated formation are maintained. Based on the pressure data obtained by the temperature pressure probe 802 in the simulated formation 9 and the pressure probe 803 in the buffer space 13, the gas pressure in the buffer space 13 is momentarily focused and adjusted to balance the cementing differential pressure generated by the invasion of the cement slurry into the simulated wellbore ring wall in the cementing and pressure maintaining process. The temperature and pressure conditions of the simulated formation within the reaction vessel are kept unchanged in the whole experimental process.

After-treatment is performed. After the injection of cement slurry is completed, the reaction vessel is quickly closed. Since the initial setting time of the cement slurry is short, in order to ensure that the system is not damaged after the test is completed, the following procedures are performed: the cement pumping machine is shut down and a high-pressure gas pump is connected to the injection port 17, and high-pressure gas is pumped into the casing cavity of the casing to push the cement slurry to return back and remove the residual cement slurry from the casing wall.
(4) Experiments and analysis of results:

Gas-water back-invasion monitoring is performed. Since hydrates can only be generated and stably exist within a very narrow window of temperature and pressure, the heat of hydration released by the hydration of the cement slurry will result in the decomposition of hydrates. Decomposition of one unit of hydrates will produce over 140 units of free gas and water which invade the cementing cement slurry under the effect of the pressure differential. The system monitors the temperature and pressure changes in the vessel in real time by means of 7 temperature and pressure probes, wherein one temperature probe 801 is placed in the cement ring 10, one pressure probe 803 is placed in the buffer space 13, and 5 temperature pressure probes 802 are placed in the simulated formation 9. These temperature and pressure probes are capable of capturing temperature and pressure data within the reaction vessel; and in the analysis of the results, the temperature and pressure change data will be used as a basis for determining the decomposition of hydrates in the simulated formation 9 and determining whether gas-water back-invasion has occurred.

Cement slurry hydration heat releasing analysis is performed. The temperature probe 801 in the cement ring 10 can monitor the temperature changes of the cement ring in real time, while the pressure probe 803 in the buffer space 13 can monitor the equilibrium pressure changes in the simulated formation 9 in real time, both of which can be used for investigating the effect of the heat releasing temperature of the cement on the degree of hydrate decomposition and the equilibrium pressure.

The invasion amount of cement slurry is observed in real time. The change in the morphology of the secondary interface and the extent of invasion of the cement slurry into the simulated wellbore ring wall can be observed in real time through the imaging probe 12 in the glass tube 11 in the cement solidification process. The simulated formation can be directly observed through the glass tube 11.

The temperature and pressure changes of the simulated formation are observed in real time. In the cementing process of the simulated formation 9, the temperature and pressure changes of the simulated formation 9 and the cement ring 10 are monitored in real time by the gas detection device, and this data is compared experimentally and can also be used as the cementing quality evaluation standard.

Sonic logging is performed. After the cement slurry sufficiently solidifies, the sonic logging probes embedded in the casing 15 are started to transmit sonic waves, and the receiver converts the sonic waves at different frequencies into data, and through the data analysis, the cementing quality of the cementing secondary interface can be obtained.

In-situ testing of the cementing strength of the secondary interface is performed. The first group of hydraulic cylinders 601 is started to lift the simulated formation 9 at a uniform velocity of 0.5 mm/s, the pressure changes of the first group of hydraulic cylinders 601 are recorded, and the shear strength is calculated; the first group of hydraulic cylinders is returned to the original positions, the first group of hydraulic cylinders 601 is restarted to lift the simulated formation 9 at a uniform velocity of 0.5 mm/s, the pressure changes of the first group of hydraulic cylinders 601 are recorded, and the shear strength is calculated; and the two shear strengths are compared, and the difference between the two shear strengths is the cementing strength of the secondary interface.

In-situ testing of the compressive strength of the cement ring is performed. After the shearing of the secondary interface is completed, the cement ring 10 is completely detached from both sides (due to the action of petroleum jelly and the plastic film, the primary interface can be approximately regarded as having no shear force between the primary interface and the cement ring 10, i.e. the primary interface is originally detached from the cement ring), the second group of hydraulic cylinders 602 is started to compress the cement ring 10 at a constant velocity of 0.5 mm/s so that the cement ring is compressed by the vessel cover, the pressure changes of the second group of hydraulic cylinders 602 are recorded, and the compressive strength of the cement ring 10 is calculated.

Pressure relief and cleaning are performed. After the completion of the experiments, the confining pressure in the buffer space 13, the pressure inside the vessel body and the hydraulic pressure of the hydraulic cylinders 6 are released, the vessel cover 19 is opened, and the simulated formation 9 and the cement ring 10 are removed.

Experimental results are analyzed.

Although this disclosure is described herein with reference to the illustrative embodiments of this disclosure, it should be understood that a person skilled in the art can design many other modifications and embodiments, which will fall within the scope and spirit of the principles disclosed in this disclosure.

What is claimed is:

1. A system for cementing simulation and gas-water back-invasion evaluation in complex formations, comprising a reaction vessel, wherein a simulated formation (9) is provided within a vessel body (23), a buffer space (13) is provided between the simulated formation (9) and an inner wall of the vessel body (23), and a cement ring (10) and a casing (15) are provided in sequence within the simulated formation (9), the three being concentric circular ring columns; a movable bottom plate (25) is provided within the vessel body (23), a vessel cover (19) and the movable bottom plate (25) seal upper and lower ends of the vessel body (23), respectively, and the movable bottom plate (25) supports the simulated formation (9), the cement ring (10) and the casing (15); an upper end of the casing (15) is in sealed connection with the vessel cover (19), and a lower end of the casing (15) is in sealed connection with the movable bottom plate (25);
two groups of hydraulic cylinders (6) are provided below the movable bottom plate (25), a first group of hydraulic cylinders (601) is placed below the simulated formation (9), and a second group of hydraulic cylinders (602) is placed below the cement ring (10);
the casing (15) has a casing cavity (24), a cement return hole (27) is provided at a lower portion of the casing (15), and the cement return hole (27) is in communication with a cementing annulus where the cement ring (10) is located;
sonic logging probes (16) are provided within the reaction vessel;
a gas detection device is provided within the reaction vessel, and the gas detection device comprises probes for detecting temperature and/or pressure that are distributed in the cement ring, the simulated formation and the buffer space;
the buffer space (13), the casing cavity (24), the cementing annulus and the simulated formation are all provided with tubes;
a casing body of the casing (15) has a sandwich, the sonic logging probes (16) are uniformly embedded and distributed within a casing body sandwich of the casing (15), a sonic logging data line (18) is in signal connection with the sonic logging probes (16), and the sonic logging data line (18) is placed outside a sandwich of the casing (15); and
an inner wall of the casing (15) is provided with a pressure relief hole (26) at one end close to the vessel cover (19), and the pressure relief hole (26) communicates the sandwich of the casing (15) with the casing cavity (24) of the casing (15).

2. The system for cementing simulation and gas-water back-invasion evaluation in complex formations according to claim 1, wherein the probes for detecting temperature and/or pressure are one temperature probe (801), five temperature pressure probes (802) and one pressure probe (803), the temperature probe (801) is provided within the cement ring, the five temperature pressure probes (802) are provided side by side in the simulated formation (9), and the pressure probe (803) is provided in the buffer space (13).

3. The system for cementing simulation and gas-water back-invasion evaluation in complex formations according to claim 1, wherein a visualization imaging device is provided within the reaction vessel, the visualization imaging device comprises a glass tube and an imaging probe (12) for imaging a secondary interface (30), two ends of the glass tube (11) are opened, and the glass tube (11) penetrates through the buffer space (13) and the simulated formation (9), so that an inner port of the glass tube (11) directly faces the secondary interface (30), and an outer port of the glass tube extends onto the vessel body (23) to be in sealed connection with the vessel body (23); and the imaging probe (12) is mounted within the glass tube (11).

4. The system for cementing simulation and gas-water back-invasion evaluation in complex formations according to claim 1, wherein the movable bottom plate (25) comprises a movable upper plate (2501), a movable lower plate (2502) and a central plate (2503) which are provided in an embedded manner, the movable upper plate (2501), the movable lower plate (2502) and the central plate (2503) are combined to form a bottom of the closed vessel body (23), and a connecting position of the movable upper plate (2501), the movable lower plate (2502) and the central plate (2503) is filled with a sealed rubber gasket (2504).

5. The system for cementing simulation and gas-water back-invasion evaluation in complex formations according to claim 4, wherein each group of hydraulic cylinders comprises two hydraulic cylinders, the first group of hydraulic cylinders (601) is placed below the simulated formation (9) with the secondary interface (30) as a boundary, and two hydraulic cylinders in the first group of hydraulic cylinders (601) are distributed on left and right sides of a lower end of the simulated formation (9); and the second group of hydraulic cylinders (602) is placed below the cement ring (10) with a primary interface (29) and the secondary interface (30) as boundaries, and two hydraulic cylinders in the second group of hydraulic cylinders (602) are distributed on left and right sides of a lower end of the cement ring (10).

6. The system for cementing simulation and gas-water back-invasion evaluation in complex formations according to claim 1, wherein an inner side wall of the simulated formation (9) is provided with a water-soluble film (22), and an outer side wall of the simulated formation (9) is provided with a sand-barrier mesh.

7. The system for cementing simulation and gas-water back-invasion evaluation in complex formations according to claim 6, wherein a rotating shaft (1) is mounted on the vessel body (23), and the rotating shaft (1) is used for being connected with a rotating device, thereby realizing rotation of the vessel body.

8. A method for cementing simulation and gas-water back-invasion evaluation in complex formations adopting the system according to claim 1, comprising the following steps:
(1) Preparation Phase:
the simulated formation is prepared in the reaction vessel, and the gas detection device and the visualization imaging device are mounted; the water-soluble film and the sand-barrier mesh are provided;
a porosity of the simulated formation is adjusted until a difference between the porosity of the simulated formation and an “average value of a porosity of a target formation” the average value of the porosity of the target formation is <10%;
an outside of the casing is coated with petroleum jelly and wrapped with a plastic film, the casing is then mounted on the vessel cover, and the reaction vessel is resealed;
water bath temperature control is performed on the vessel body until temperature of the simulated formation reaches temperature of the target formation;
(2) Hydrate Generation Phase:
methane and pore water are injected into the simulated formation, the reaction vessel is rotated to make distribution of the pore water uniform, and water bath temperature conditions outside the vessel body are kept unchanged until a hydrate is generated;
(3) Cementing Phase:
after well washing, cement slurry is injected into the casing, the reaction vessel is closed, and the cement slurry is pushed to return back;
pressure of the cement slurry is made higher than pressure of the buffer space by a manner of injecting nitrogen into the simulated formation, and the pressure is maintained until the cement slurry solidifies; and
(4) Obtaining of Experimental Data:
the temperature and pressure within the reaction vessel are obtained through the temperature and/or pressure probes;
the secondary interface is observed through the imaging probe;
after the cement slurry solidifies, the sonic logging probes are started to emit sonic waves, and a receiver obtains the sonic waves; then, the first group of hydraulic cylinders is started twice to lift the simulated formation, pressure changes of the first group of hydraulic cylinders are recorded twice, two shear strengths are calculated by the pressure changes, and a difference of the two shear strengths is obtained as a shear strength of the secondary interface; and finally, the second group of hydraulic cylinders is started to compress the cement ring, and pressure changes of the second group of hydraulic cylinders are recorded as a compressive strength of the cement ring.
